(19) United States
(12) Patent Application Publication
(10) Pub. No.: US 2004/0031111 A1
(43) Pub. Date: Feb. 19, 2004

(54) Disposable dust receptacle

(76) Inventors: Jose Porchia, Greenfield, WI (US); Pamela T. Moy, Lake Forest, IL (US)

Correspondence Address: S.C. JOHNSON & SON, INC., 1525 HOWE STREET, RACINE, WI, 53403-2236, US

(21) Appl. No.: 10/218,798

(22) Filed: Aug. 14, 2002

(51) Int. Cl. A47L 11/33; A47L 11/40

(52) U.S. Cl. 15/52.1; 15/41.1; 15/257.1

(57) ABSTRACT

A disposable dust receptacle can be formed from a foldable blank. It has flaps that close an open end so that the receptacle closes automatically as the receptacle is removed from a cleaning machine. The receptacle can be constructed from a biodegradable material, and is most suitable for use with cleaning machines having rotary brushes.

### CROSS REFERENCE TO RELATED APPLICATIONS

Not applicable.

### STATEMENT REGARDING FEDERALLY SPONSORED RESEARCH/DEVELOPMENT

Not applicable

### BACKGROUND OF THE INVENTION

This invention relates to cleaning machines such as those use rotary brushes to lift small particulate matter from a carpet, a floor or the like. More particularly it relates to a disposable receptacle for collecting such particulate matter.

Vacuum cleaners, hand-held floor cleaners, and more recently robotic cleaners have been developed for floor care. Many of these have rotary brushes that have an axis of rotation parallel to the surface to be cleaned. Some of the rotary brushes are motor driven. Others are linked by gears to wheels or other structures that are moved by the user. These brushes usually extend downward to the surface to be cleaned, and as they rotate flick the particulate upward into the cleaner housing.

In the case of robotic cleaners, the housing is also provided with control devices to cause the cleaner to follow a selected path. Sensors may also be provided around the perimeter of the device to provide feedback to a robotic control system, which may change the path of the cleaning device based on the position of sensed obstacles.

Regardless of the type of cleaning device, most provide a space in the housing where particulate from the brush can be directed for storage. Preferable, the space is in the form of a removable, disposable receptacle. As in the case with many vacuum cleaner bags, the receptacles are typically provided with an open end so as to be easily connectible to a chute that delivers the dirt, or so as to be able to receive the dirt without interference.

When such a receptacle is uncoupled or otherwise removed from the cleaning device, there is sometimes a puff of dirt expelled from the receptacle back into the atmosphere. Apart from this creating an additional need to dust the area affected by this puff, the expelled dirt/dust can be problematic for those with asthma or other respiratory concerns.

Also, some of the prior art dirt receptacles are permanent or semi-permanent parts of the machine. As they are used and periodically emptied, they may become coated with dirt that cannot be easily removed or cleaned, and thus may become breeding grounds for bacteria and the like.

The concept of a disposable dust receptacle is, of course, well known. For example, U.S. Pat. No. 2,960,714 discloses a combination carpet sweeper and vacuum cleaner. The device collects dirt in a removable paper container provided with a strip of pressure sensitive adhesive for engaging the container with the wall of the cleaner. A flap can be folded over the container to prevent the release of dust after removal from the device.

Similarly, U.S. Pat. No. 2,227,104 discloses a cardboard dust receptacle for insertion into a brush-driven carpet sweeper. The dust receptacle includes a string closure element which is pulled by the user to force the walls of the dust receptacle together to prevent spillage.

See also U.S. Pat. Nos. 3,482,276, and to a lesser extent 1,082,128, for other teachings of receptacles used to collect dust that are associated with cleaning devices.

These prior art dust receptacles had the advantage of disposability. However, they were unduly expensive to manufacture and relied on the user to provide the closure. As such, there was a period in which the receptacle would be open after it was removed until the user either closed it, or disposed of the receptacle.

Moreover, while some prior art receptacles such as vacuum cleaner bags could be stored and sold in compact folded fashion, and then expanded immediately prior to use, other such receptacles could not. Further, the techniques used with vacuum cleaner bags made them awkward to expand, and in many cases relied on a plurality of different materials being used.

In separate work, the art had developed a number of pans, boxes and other containers into which waste material can be manually placed. Some of these structures were made from a cardboard or paper flat blank that was designed to be folded into an erected shape. For example, U.S. Pat. No. 3,534,424 discloses a collapsible dustpan which was assembled from a cardboard blank. It also disclosed a cover which could be folded over to enclose the dust inside.

Also, U.S. Pat. No. 4,017,015 disclosed a two piece closeable disposable pet waste container, and U.S. Pat. No. 6,102,278 disclosed a foldable pan for collecting dirt which does not include a cover. See also U.S. Pat. Nos. 3,765,044 and 3,995,807.

These devices provide waste receptacles which can be disposed of after use. However, they are not designed for attachment to a cleaning machine. Furthermore, these require the user to close the structure (apart from any movement of the overall receptacle).

Accordingly, there is a need for improved dust receptacles for use with cleaning machines.

### SUMMARY OF THE INVENTION

The present invention provides a dust receptacle that can be easily and inexpensively constructed, positioned in and removed from cleaning devices, and then disposed of in a manner that minimizes a user's contact with the dust inside the receptacle.

In one form the invention provides a disposable dust receptacle in the form of a box having an openable end for permitting dust to enter the receptacle when the end is open. There is also a cover that closes at least in part automatically when the box is removed from the cleaning device (e.g. due to gravity causing a box flap to drop).

In preferred forms the receptacle has been constructed from a flat, foldable blank of material, the cover has a first flap and a second flap, each being positioned adjacent said openable end, and there is a channel cut into at least one of the first and second flaps. The other flap can be partially slid into the channel to assist in maintaining the cover in a closed position. A preferred shape for the box is a generally rectangular shape, albeit other shapes would also suffice consistent with the device with which the receptacle will be used.

The box can be made of cardboard or paper, which are readily biodegradable. Alternatively, other materials can be used such as plastics, rubber materials, or cloths.

In another form the invention provides a cleaning device having a housing containing a rotatable brush suitable for contacting a surface below the cleaning device. There is an outlet positioned on the housing, a disposable dust receptacle of the above type removably mountable to the outlet, and a brush extending from the bottom of the housing to contact and clean a surface below the cleaning device.

Preferably, the outlet is in the form of a chute having a first open end and a second open end, the first open end of the chute being positioned in proximity to the brush to receive dirt thrown up by the brush, and the second open end of the chute being positioned in proximity to the dust receptacle when the dust receptacle is mounted to the outlet. In such a device the housing has an openable door for covering and controlling access to the dust receptacle when it is mounted to the outlet.

In another aspect the device can be a robotic cleaner having controls positioned in the housing to control movement of the device, and the receptacle can be sized and dimensioned to be press-fit over an end of the chute.

The receptacle can be readily constructed from a pre-scored flat, foldable blank. Thus, it can be stored in a flat, compact form for shipment or sale.

When ready to use, it can be quickly erected by a consumer, and an open end of the receptacle can be slid over a mounting chute of the cleaning device. The flaps adjacent the openable end can easily be moved out of the way during this procedure as they are provided with opposed teeter totter portions that can be held against the box sides when the receptacle is being slid on the chute.

When the receptacle is slid off the chute (after it is sufficiently filled), the weight of the upper flap will (due to gravity or the resilience of the material) cause it to drop down to at least partially cover the openable end of the receptacle. This immediate closure significantly reduces the incidence of dust puffs coming back out from the box.

A locking tab on that flap can then be interlocked with the second flap to secure the closure. The closed receptacle can then be tossed into the garbage, and a new receptacle can be erected and installed.

This brief summary of the invention has been provided so that the general nature of the invention may be understood. However, neither this summary, nor the description of the preferred embodiments which follows, should be construed to limit the invention. Rather, the claims should be looked to in order to determine the full scope of the invention.

### BRIEF DESCRIPTION OF THE DRAWINGS

FIG. 1 is an upper, right perspective view of a dust receptacle constructed in accordance with the present invention, with its front access flaps shown in the closed position;

FIG. 2 is an upper left perspective view of a foldable blank suitable for constructing the dust receptacle of FIG. 1;

FIG. 3 is an upper left perspective view of the blank of FIG. 2, with opposed ends of the blank linked together, but with the thereby partially assembled blank still folded for storage or sale;

FIG. 4 is a left end perspective view of the dust receptacle of FIG. 1;

FIG. 5 is a view similar to FIG. 1, but with the access flaps shown in the open position;

FIG. 6 is a side view, partially broken away, showing a cleaning machine in which the FIG. 1 dust receptacle has been installed;

FIG. 7 is an enlarged sectional view of a portion of the FIG. 6 view, showing the receptacle flap relative to a chute of the cleaning machine; and

FIG. 8 is a view similar to FIG. 7, but with the receptacle having just been removed from the cleaning machine.

### DESCRIPTION OF THE PREFERRED EMBODIMENTS

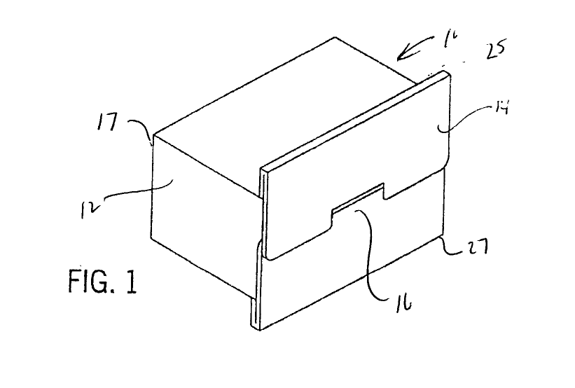

Referring first to FIGS. 1, 2 and 5, the preferred dust receptacle 10 is in the form of a box with a side openable end that has pivotable closure flaps/panels 14, 16. The panel 14 can have two slits 29 and 31 to define a closure tab there between.

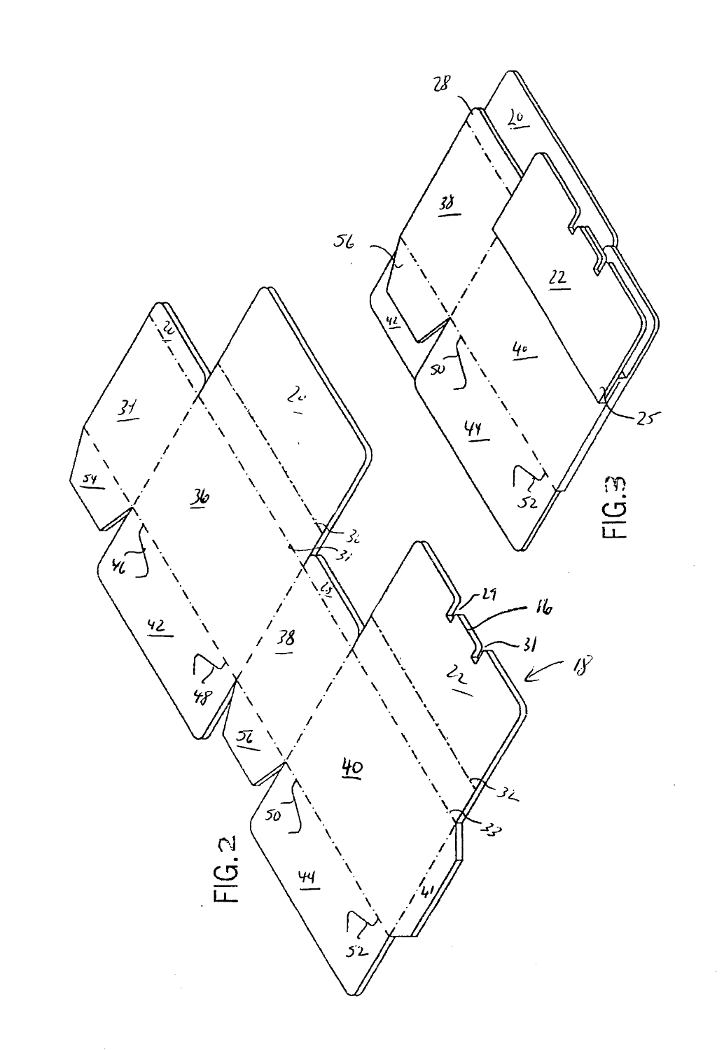

The entire box is preferably constructed from cardboard from a pre-scored foldable blank as shown in FIG. 2. It will be appreciated that the receptacle 10 can be stored, shipped and sold to the consumer in the FIG. 2 form, or glue flap 41 can be pre-attached to end 34 at the factory to create the FIG. 3 form.

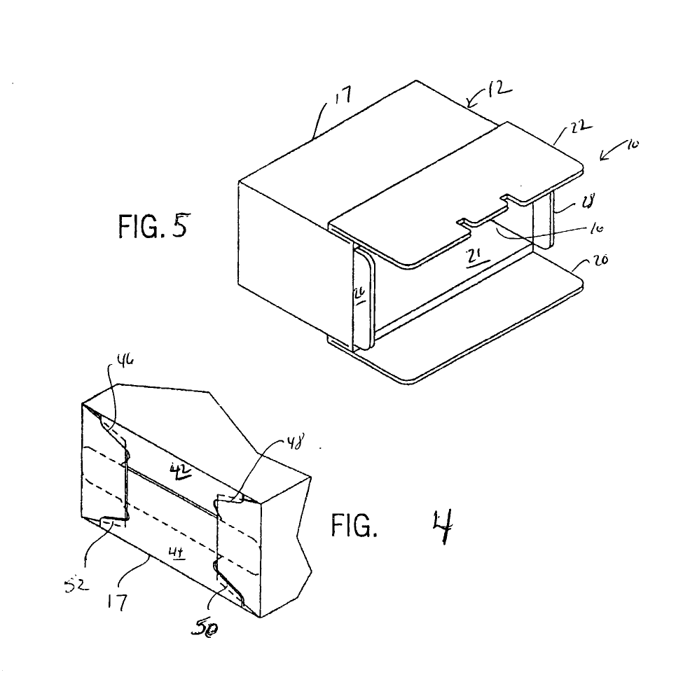

As will be best appreciated from FIGS. 5-7, an openable end 21 of the box 12 has a size generally suitable to be press-fit onto a chute, channel, hose, or tube in a selected cleaning device 72. A blank 18 has side panels 34, 36, 38, and 40. The openable end is coverable by the flaps 20, 22, 26, and 28. The opposite end 17 is constructed from the flaps 42, 44, 54, and 56.

The main flaps 20 and 22 are sized and dimensioned to form teeter totter flaps due to the extra fold-back regions between region 22 and 40 and between region 20 and 36. The channels 29 and 31 form the locking tab 16.

To form the closing flaps 25 and 27, the flaps 20 and 22 are each initially folded outward, away from the center of the box 12, along the score lines 31 and 33, respectively. Each of the flaps 20 and 22 are then folded back inward toward the center of the box 12, along the score lines 30 and 32, respectively, to form the overhanging edges 25 and 27. The resulting flaps comprise a double layer of material extending horizontally outward from the side of the box 12.

Gravity, and the resilience of the material, will cause at least flap 22 to pivot to the closed position when it is not held up. Further, the resilience of the material will cause flap 20 to at least partially pivot towards the closed position when it is not held down.

The end flaps 42, 44, 54, and 56 form a usually closed end 17 of the box 12. The flap 42 includes locking slits 46 and 48, and the flap 44 includes locking slits 50 and 52. These receive the flaps 54 and 56 in the fashion shown in FIG. 4.

To construct the dust receptacle 10 from the stored, flattened position, a user can, for example, force the sides 40 and 36 apart to form the sides of the rectangular box 12. The flaps 42 and 44 are folded inward toward the center of the box 12 along the associated score lines, and the flaps 54 and 56 are folded and inserted into the slits 46, 48, 50, and 52 to form the end 17 of the box 12.

When folded into this configuration, dust, dirt, and other particulate matter can be stored in the box 12. The opening 21 of the box 12 between the flaps 20 and 22 is sized and dimensioned to be press-fit onto a chute, tube, or hose in a cleaning machine, as described below. The scored lines along the edges of the flaps 20 and 22 are pre-folded toward the open end 21 of the box 12 to enclose the opening automatically when the dust receptacle 10 is removed from the chute, tube, or hose, also as described below.

It should be particularly appreciated that the region of the flaps 22 and 20 that is doubled back on itself provides a finger region for the consumer to hold the box in the open position as it is being installed. That region also provides significant resilience causing a tendency of the flap to move towards the closed position. This reduces leakage of dust along the joint between the chute and the box.

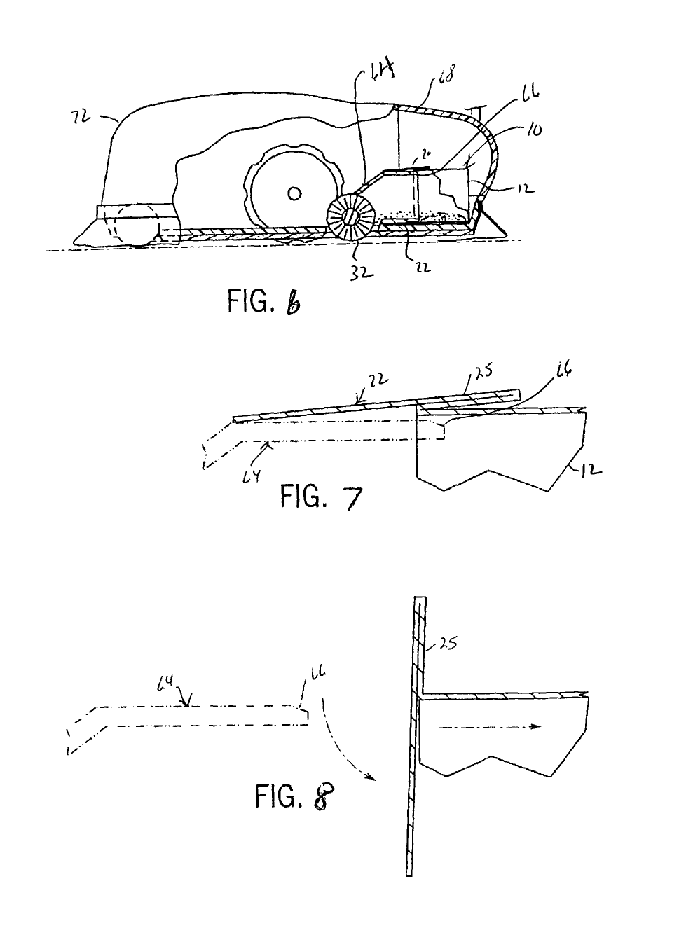

Referring next to FIG. 6, an autonomous robotic cleaning device 60 is shown in which is positioned the dust receptacle 10. The robotic cleaning device 60 includes a housing 72 having a control system for controlling the motion of the device and a brush 62 which is applied to a surface to be cleaned, typically a floor.

A chute 64 is positioned to receive the dust, dirt, and particulate matter picked up by the brush 62 and to direct the dirt to the dust receptacle 10, which is press-fit onto the end 66 of the chute 64. The dust receptacle 10 is inserted into the robotic cleaning device 60 through a hinged door 68 located in a top 70 of the housing 72.

In operation, a user inserts the dust receptacle 10 through the hinged door 68 and inserts the dust receptacle 10 onto the chute 64, as shown in FIG. 7. Although the open end 21 of the box 12 is preferably press-fit onto the chute 64, spring-loaded retainer devices, elastic devices, hook and loop fasteners, and other types of coupling devices and retainers could also be used for retaining the dust receptacle 10 on the chute 64.

As the cleaning device 60 traverses a surface to be cleaned, dust, dirt, and particulate matter is lifted off of the surface being cleaned by the brush 62, directed into the chute 64, and from the chute 64 into the dust receptacle 10. When the cleaning operation is complete, and the box is sufficiently filled, the user removes the dust receptacle 10 by again opening the hinged door 68, and removing the dust receptacle 10 from the chute 64.

Referring now to FIG. 8, as the box 12 is removed, the pre-folded flaps 20 and 22 swing automatically towards each other to cover the open end 21 of the box 12. The cover 14 can also be more quickly forced together by a user applying a further pivoting force. The box 12 is, therefore, easily essentially automatically. The locking tab 16 couples the flaps 20 and 22 together, locking the dust, dirt, and particulate matter into the dust receptacle 10.

Although the dust receptacle 10 has been described with reference to an autonomous robotic cleaning device 60, the dust receptacle 10 can also be used with other types of cleaning machines.

Furthermore, the dust receptacle 10 can also be used as a waste receptacle for applications such as a pet waste container. In this application, a user inserts the waste into the container and then forces the overhanging edges 25 and 27 to shut over the open end 21 of the receptacle 10.

Thus, although specific embodiments of the present invention have been described in detail, it will be understood that this description is merely for purposes of illustration. Various modifications may be made without departing from the spirit of the following claims. Furthermore, although the preferred receptacle is formed from a foldable blank, the receptacle can be formed in erected form. Accordingly, the claims should be looked to in order to judge the full scope of the invention.

Industrial Applicability

Improved disposable dust receptacles are provided for use with cleaning machines.

We claim:

1. A disposable receptacle, the dust receptacle comprising:
a box having an openable end for permitting dust to enter the receptacle when the end is open; and
a cover that can close at least in part automatically when the box is removed from the cleaning device.

2. The disposable receptacle of claim 1, wherein the receptacle has been constructed from a flat, foldable blank of material.

3. The disposable receptacle of claim 1, wherein the cover comprises a first flap and a second flap, each being positioned adjacent said openable end.

4. The disposable receptacle of claim 3, further comprising a channel cut into at least one of the first and second flaps, wherein the other flap can be partially slid into the channel to assist in maintaining the cover in a closed position.

5. The disposable receptacle of claim 1, wherein the receptacle is made of a cardboard material.

6. The disposable receptacle of claim 1, wherein the openable end is essentially rectangular.

7. The disposable receptacle of claim 1, wherein the cover further comprises an overhanging folding flap, the folding flap comprising a double layer of material which hinges on the edge of the box to enclose the openable end of the box.

8. A cleaning device, comprising:
a housing containing a rotatable brush suitable for contacting a surface below the cleaning device;
an outlet positioned on the housing;
a disposable dust receptacle removably mountable to the outlet, wherein the receptacle is a claim 1 receptacle; and
a brush extending from the bottom of the housing to contact and clean a surface below the cleaning device.

9. The cleaning device of claim 7, wherein the outlet is in the form of a chute having a first open end and a second open end, the first open end of the chute being positioned in proximity to the brush to receive dirt thrown up by the brush, and the second open end of the chute being positioned in proximity to the dust receptacle when the dust receptacle is mounted to the outlet.

10. The cleaning device of claim 8, wherein the housing has an openable door for covering and controlling access to the dust receptacle when it is mounted to the outlet.

11. The cleaning device of claim 7, wherein the device is a robotic cleaner and the device further comprises controls in the housing to control movement of the device.

12. The cleaning device of claim 7, wherein the receptacle is sized and dimensioned to be press-fit over an end of the chute.
